(19) United States
(12) Patent Application Publication
(10) Pub. No.: US 2023/0397544 A1
(43) Pub. Date: Dec. 14, 2023

(54) SYSTEM AND METHOD FOR THERMAL RADIATION MANAGEMENT FOR GARDENING APPLIANCE

(71) Applicant: Haier US Appliance Solutions, Inc., Wilmington, DE (US)

(72) Inventors: Vineeth Vijayan, Louisville, KY (US); Sarah Heiniger, Louisville, KY (US)

(21) Appl. No.: 17/837,349

(22) Filed: Jun. 10, 2022

(51) Int. Cl. A01G 9/24

(52) U.S. Cl. CPC A01G 9/249

(57) ABSTRACT

A gardening appliance and method for thermal management at a gardening appliance is provided. The gardening appliance includes a cabinet defining a grow chamber within the cabinet, a light assembly configured to emit light into the grow chamber, and a transparent shield positioned between the light assembly and the grow chamber. The method includes positioning a transparent shield between a grow chamber and a light assembly and applying a wavelength filter coating to the transparent shield and emitting light toward the grow chamber. The transparent shield including the wavelength filter coating is configured to inhibit light wavelengths beyond a predetermined range of light wavelength from entering the grow chamber.

### FIELD OF THE INVENTION

The present subject matter relates generally to systems for gardening plants indoors, and more particularly, to a system and method for regulating the internal environment in a garden center.

### BACKGROUND OF THE INVENTION

Conventional indoor garden centers include a cabinet defining a grow chamber having a number of trays or racks positioned therein to support seedlings or plant material, e.g., for growing herbs, vegetables, or other plants in an indoor environment. In addition, such indoor garden centers may include an environmental control system that maintains the growing chamber at a desired temperature and humidity. Certain indoor garden centers may also include hydration systems for watering the plants and/or artificial lighting systems that provide the light necessary for such plants to grow.

Various wavelength spectrums of light may promote plant growth at the grow chamber. Certain spectrums may primarily provide thermal radiation into the grow chamber, which in turn generates heat. Excessive heat may cause higher energy consumption by the garden center, require greater cooling and heat removal, or provide detrimental levels of heat to the plant.

Accordingly, an improved indoor garden center would be useful. More particularly, an indoor garden center with an improved thermal management system would be particularly beneficial.

### BRIEF DESCRIPTION OF THE INVENTION

Aspects and advantages of the invention will be set forth in part in the following description, or may be apparent from the description, or may be learned through practice of the invention.

An aspect of the present disclosure is directed to a gardening appliance. The gardening appliance includes a cabinet defining a grow chamber within the cabinet, a light assembly configured to emit light into the grow chamber, and a transparent shield positioned between the light assembly and the grow chamber. The transparent shield includes a wavelength filter coating. The wavelength filter coating is configured to inhibit light wavelengths beyond a predetermined range of light wavelength from entering the grow chamber.

Another aspect of the present disclosure is directed to a method for thermal management at a gardening appliance. The method includes applying a wavelength filter coating to a transparent shield; positioning the transparent shield between the grow chamber and the light assembly, the light assembly configured to emit light toward the grow chamber; and emitting light toward the grow chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a gardening appliance according to an exemplary embodiment of the present subject matter.

FIG. 2 depicts a front view of the exemplary gardening appliance of FIG. 1 with the doors open according to an exemplary embodiment of the present subject matter.

FIG. 3 is a cross sectional view of the exemplary gardening appliance of FIG. 1, taken along Line 3-3 from FIG. 2.

FIG. 4 depicts a top-down cutaway view of the exemplary gardening appliance of FIG. 1 according to an exemplary embodiment of the present subject matter.

FIG. 5 depicts a perspective cutaway view of a portion of a grow module of the exemplary gardening appliance of FIG. 1 according to an exemplary embodiment of the present subject matter.

FIG. 6 depicts a perspective view of the grow module of the exemplary gardening appliance of FIG. 1 according to an exemplary embodiment of the present subject matter.

FIG. 7 depicts a perspective view of the grow module of the exemplary gardening appliance of FIG. 1 according to an exemplary embodiment of the present subject matter.

FIG. 8 is a perspective view of a light assembly and transparent shield for a gardening appliance according to an exemplary embodiment of the present disclosure.

FIG. 9 provides a flowchart outlining steps of a method for thermal management at a gardening appliance according to an exemplary embodiment of the present subject matter.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, terms of approximation, such as “approximately,” “substantially,” or “about,” refer to being within a ten percent (10%) margin of error of the stated value. Moreover, as used herein, the terms “first,” “second,” and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows.

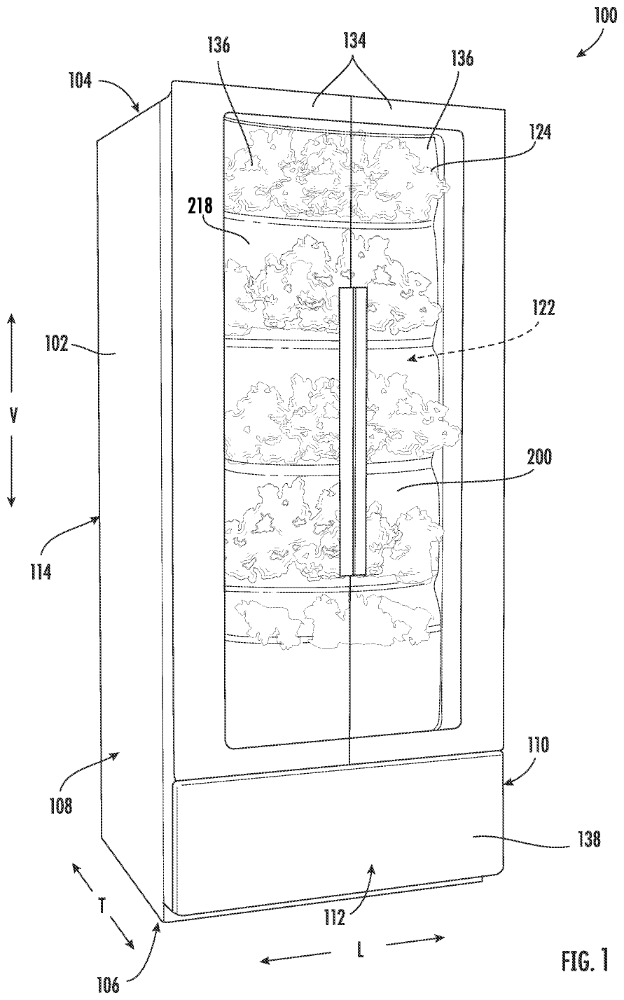

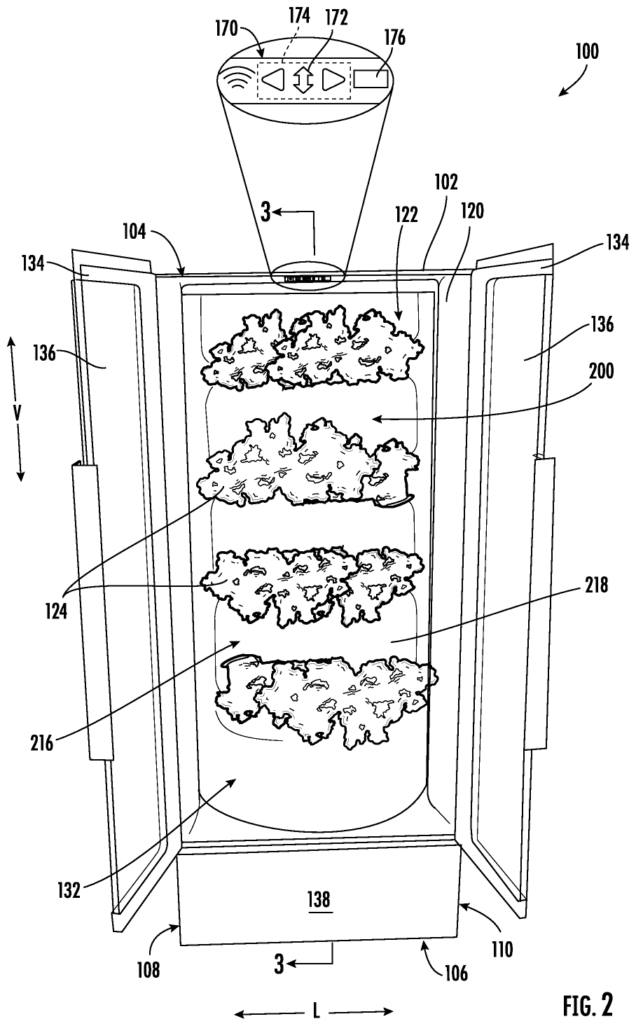

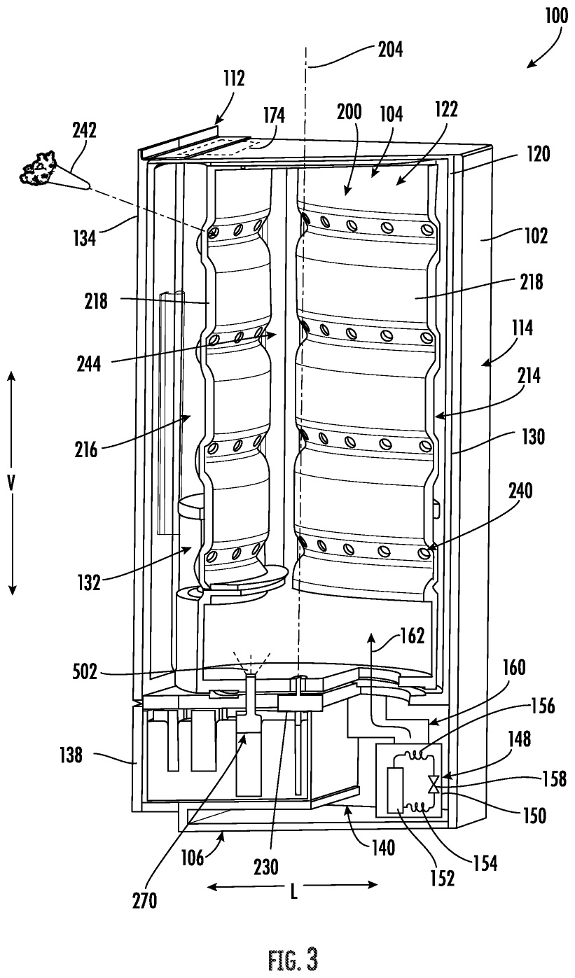

FIG. 1 provides a front view of a gardening appliance 100 according to an exemplary embodiment of the present subject matter. FIG. 2 depicts a front view of the exemplary gardening appliance of FIG. 1 with the doors open. FIG. 3 is a cross sectional view of the exemplary gardening appliance of FIG. 1, taken along Line 3-3 from FIG. 2. According to exemplary embodiments, gardening appliance 100 may be used as an indoor garden center for growing plants. It should be appreciated that the embodiments described herein are intended only for explaining aspects of the present subject matter. Variations and modifications may be made to gardening appliance 100 while remaining within the scope of the present subject matter.

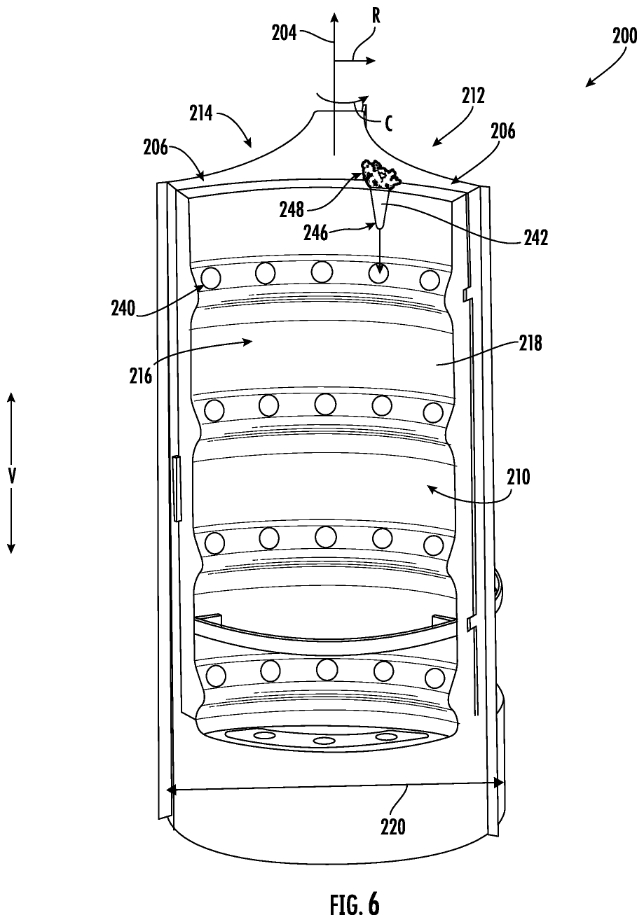

Referring now generally to FIGS. 1 through 8, gardening appliance 100 includes a housing or cabinet 102 that extends between a top 104 and a bottom 106 along a vertical direction V, between a first side 108 and a second side 110 along a lateral direction L, and between a front side 112 and a rear side 114 along a transverse direction T. Each of the vertical direction V, lateral direction L, and transverse direction T are mutually perpendicular to one another and form an orthogonal direction system.

Gardening appliance 100 may include an insulated liner 120 (FIG. 3) positioned within cabinet 102. Cabinet 102 may generally form a temperature controlled chamber, referred to herein generally as a grow chamber 122, within which plants 124 may be grown. Liner 120 may at least partially define grow chamber 122 within cabinet 102. For example, the grow chamber 122 may include a front portion and one or more back portions and the liner 120 may at least partially define the one or more back portions of the grow chamber 122. Although gardening appliance 100 is referred to herein as growing plants 124, it should be appreciated that other organisms or living things may be grown or stored in gardening appliance 100. For example, algae, fungi (e.g., including mushrooms), or other living organisms may be grown or stored in gardening appliance 100. The specific application described herein is not intended to limit the scope of the present subject matter.

Cabinet 102, or more specifically, liner 120 may define a substantially enclosed back region or portion 130 (FIG. 3). In addition, cabinet 102 and liner 120 may define a front opening, referred to herein as front display opening 132, through which a user of gardening appliance 100 may access grow chamber 122, e.g., for harvesting, planting, pruning, or otherwise interacting with plants 124. According to an exemplary embodiment, enclosed back portion 130 may be defined as a portion of liner 120 that defines grow chamber 122 proximate rear side 114 of cabinet 102. In addition, front display opening 132 may generally be positioned proximate or coincide with front side 112 of cabinet 102.

Gardening appliance 100 may further include one or more doors 134 that are rotatably mounted to cabinet 102 for providing selective access to grow chamber 122. For example, FIG. 1 illustrates doors 134 in the closed position such that they may help insulate grow chamber 122. By contrast, FIG. 2 illustrates doors 134 in the open position for accessing grow chamber 122 and plants 124 stored therein. Doors 134 may further include a transparent window 136 through which a user may observe plants 124 without opening doors 134.

Although doors 134 are illustrated as being rectangular and being mounted on front side 112 of cabinet 102 in FIGS. 1 and 2, it should be appreciated that according to alternative embodiments, doors 134 may have different shapes, mounting locations, etc. For example, doors 134 may be curved, may be formed entirely from glass, etc. In addition, doors 134 may have integral features for controlling light passing into and/or out of grow chamber 122, such as internal louvers, tinting, UV treatments, polarization, etc. One skilled in the art will appreciate that other chamber and door configurations are possible and within the scope of the present invention.

According to the illustrated embodiment, cabinet 102 further defines a drawer 138 positioned proximate bottom 106 of cabinet 102 and being slidably mounted to cabinet for providing convenient storage for plant nutrients, system accessories, water filters, etc. In certain embodiments, such as depicted in FIG. 3, an environmental control system 148 may be positioned behind drawer 138 at a mechanical compartment 140. The environmental control system 148 may include a sealed system for regulating the temperature within grow chamber 122.

FIG. 3 provides a schematic view of certain components of an environmental control system 148 that may be used to regulate a temperature within grow chamber 122. Specifically, environmental control system 148 may include a sealed system 150, a duct system 160, and a hydration system 500 which provides a spray or mist 502 of water, or any other suitable components or subsystems for regulating an environment within grow chamber 122, e.g., for facilitating improved or regulated growth of plants 124 positioned therein. Specifically, FIG. 3 illustrates sealed system 150 within mechanical compartment 140. Although an exemplary sealed system is illustrated and described herein, it should be appreciated that variations and modifications may be made to sealed system 150 while remaining within the scope of the present subject matter. For example, sealed system 150 may include additional or alternative components, different ducting configurations, etc.

As shown, sealed system 150 includes a compressor 152, a first heat exchanger or evaporator 154 and a second heat exchanger or condenser 156. As is generally understood, compressor 152 is generally operable to circulate or urge a flow of refrigerant through sealed system 150, which may include various conduits which may be utilized to flow refrigerant between the various components of sealed system 150. Thus, evaporator 154 and condenser 156 may be between and in fluid communication with each other and compressor 152.

During operation of sealed system 150, refrigerant flows from evaporator 154 and to compressor 152, and compressor 152 is generally configured to direct compressed refrigerant from compressor 152 to condenser 156. For example, refrigerant may exit evaporator 154 as a fluid in the form of a superheated vapor. Upon exiting evaporator 154, the refrigerant may enter compressor 152, which is operable to compress the refrigerant. Accordingly, the pressure and temperature of the refrigerant may be increased in compressor 152 such that the refrigerant becomes a more superheated vapor.

Condenser 156 is disposed downstream of compressor 152 and is operable to reject heat from the refrigerant. For example, the superheated vapor from compressor 152 may enter condenser 156 and transfer energy to air surrounding condenser 156 (e.g., to create a flow of heated air). In this manner, the refrigerant condenses into a saturated liquid and/or liquid vapor mixture. A condenser fan (not shown) may be positioned adjacent condenser 156 and may facilitate or urge the flow of heated air across the coils of condenser 156 (e.g., from ambient atmosphere) in order to facilitate heat transfer.

According to the illustrated embodiment, an expansion device or a variable electronic expansion valve 158 may be further provided to regulate refrigerant expansion. During use, variable electronic expansion valve 158 may generally expand the refrigerant, lowering the pressure and temperature thereof. In this regard, refrigerant may exit condenser 156 in the form of high liquid quality/saturated liquid vapor mixture and travel through variable electronic expansion valve 158 before flowing through evaporator 154. Variable electronic expansion valve 158 is generally configured to be adjustable, e.g., such that the flow of refrigerant (e.g., volumetric flow rate in milliliters per second) through variable electronic expansion valve 158 may be selectively varied or adjusted.

Evaporator 154 is disposed downstream of variable electronic expansion valve 158 and is operable to heat refrigerant within evaporator 154, e.g., by absorbing thermal energy from air surrounding the evaporator (e.g., to create a flow of cooled air). For example, the liquid or liquid vapor mixture refrigerant from variable electronic expansion valve 158 may enter evaporator 154. Within evaporator 154, the refrigerant from variable electronic expansion valve 158 receives energy from the flow of cooled air and vaporizes into superheated vapor and/or high quality vapor mixture. An air handler or evaporator fan (not shown) is positioned adjacent evaporator 154 and may facilitate or urge the flow of cooled air across evaporator 154 in order to facilitate heat transfer. From evaporator 154, refrigerant may return to compressor 152 and the vapor-compression cycle may continue.

As explained above, certain embodiments of the environmental control system 148 may include a sealed system 150 for providing a flow of heated air or a flow cooled air throughout grow chamber 122 as needed. To direct this air, environmental control system 148 includes a duct system 160 for directing the flow of temperature regulated air, identified herein simply as flow of air 162 (see, e.g., FIG. 3). In this regard, for example, an evaporator fan can generate a flow of cooled air as the air passes over evaporator 154 and a condenser fan can generate a flow of heated air as the air passes over condenser 156.

These flows of air 162 may be routed through a cooled air supply duct and/or a heated air supply duct (not shown), respectively. In this regard, it should be appreciated that environmental control system 148 may generally include a plurality of ducts, dampers, diverter assemblies, and/or air handlers to facilitate operation in a cooling mode, in a heating mode, in both a heating and cooling mode, or any other mode suitable for regulating the environment within grow chamber 122. It should be appreciated that duct system 160 may vary in complexity and may regulate the flows of air from sealed system 150 in any suitable arrangement through any suitable portion of grow chamber 122. Although particular embodiments of environmental control system 148 are depicted herein, it should be appreciated that gardening appliance 100 may include any appropriate type of system for generating and providing cooled or heated air.

Gardening appliance 100 may include a control panel 170 (FIG. 2). Control panel 170 includes one or more input selectors 172, such as e.g., knobs, buttons, push buttons, touchscreen interfaces, etc. In addition, input selectors 172 may be used to specify or set various settings of gardening appliance 100, such as e.g., settings associated with a lighting assembly or operation of sealed system 150. Input selectors 172 may be in communication with a processing device or controller 174. Control signals generated in or by controller 174 operate gardening appliance 100 in response to input selectors 172. Additionally, control panel 170 may include a display 176, such as an indicator light or a screen. Display 176 is communicatively coupled with controller 174 and may display information in response to signals from controller 174. Further, controller 174 may be communicatively coupled with other components of gardening appliance 100, such as e.g., one or more sensors, motors, light sources, or other components.

As used herein, “processing device” or “controller” may refer to one or more microprocessors or semiconductor devices and is not restricted necessarily to a single element. The processing device can be programmed to operate gardening appliance 100. The processing device may include, or be associated with, one or more memory elements (e.g., non-transitory storage media). In some such embodiments, the memory elements include electrically erasable, programmable read only memory (EEPROM). Generally, the memory elements can store information accessible processing device, including instructions that can be executed by processing device. Optionally, the instructions can be software or any set of instructions and/or data that when executed by the processing device, cause the processing device to perform operations.

Referring generally to FIGS. 1 through 8, gardening appliance 100 generally includes a rotatable carousel, referred to herein as a grow module 200 that is mounted within cabinet 102 or liner 120, e.g., such that it is within grow chamber 122. As illustrated, grow module 200 includes a central hub 202 that extends along and is rotatable about a central axis 204. Specifically, according to the illustrated embodiment, central axis 204 is parallel to the vertical direction V. However, it should be appreciated that central axis 204 could alternatively extend in any suitable direction, e.g., such as the horizontal direction. In this regard, grow module 200 generally defines an axial direction, i.e., parallel to central axis 204, a radial direction R that extends perpendicular to central axis 204, and a circumferential direction C that extends around central axis 204 (e.g., in a plane perpendicular to central axis 204).

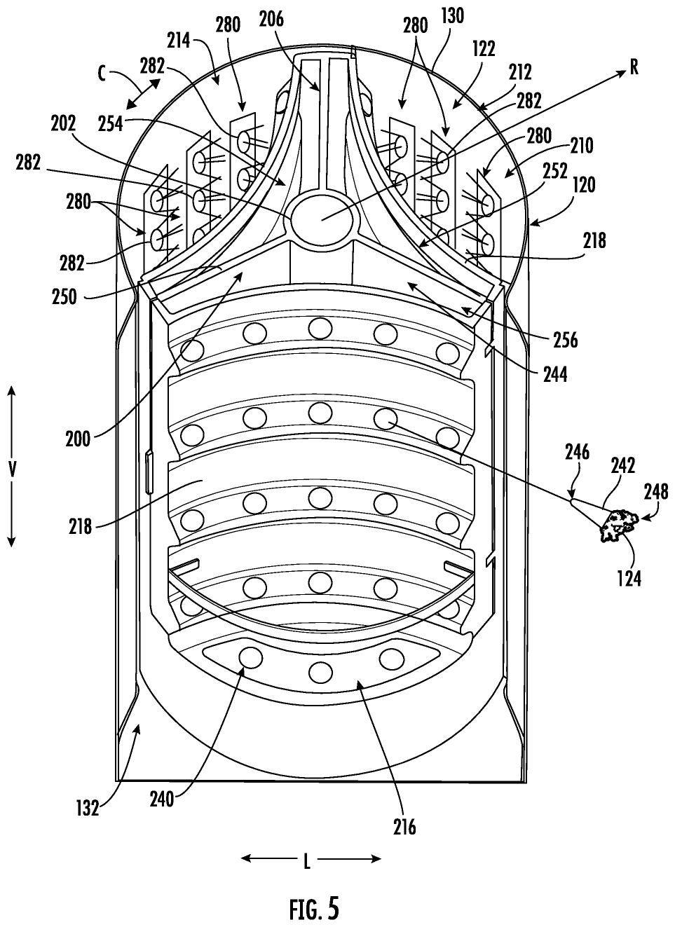

Grow module 200 may further include a plurality of partitions 206 that extend from central hub 202 (FIG. 5) substantially along the radial direction R. In this manner, grow module 200 defines a plurality of portions of the grow chamber, referred to herein generally by reference numeral 210, by dividing or partitioning grow chamber 122 into the separate portions. Referring specifically to a first embodiment of grow module 200 illustrated in FIGS. 1 through 7, grow module 200 includes three faces, and each face of the grow module 200 is positioned within one of the portions 210 of the grow chamber 122. In additional embodiments, the grow module 200 may include, e.g., two faces or more than three faces, such as four faces, five faces, six faces, or more. In particular, the illustrated exemplary grow module 200 includes a first face 212 in a back right portion 210 of the grow chamber 122, a second face 214 in a back left portion 210 of the grow chamber 122, and a third face 216 in a front portion 210 of the grow chamber 122. In general, as grow module 200 is rotated within grow chamber 122, the plurality of portions 210 of the grow chamber 122 define substantially separate and distinct growing environments, e.g., for growing plants 124 having different growth needs, and the faces 212, 214, and 216 of the grow module 200 may travel successively through the distinct environments of the different portions 210 of the grow chamber 122.

More specifically, partitions 206 may extend from central hub 202 to a location immediately adjacent liner 120. Although partitions 206 are described as extending along the radial direction, it should be appreciated that they need not be entirely radially extending. For example, according to the illustrated embodiment, the distal ends of each partition are joined with an adjacent partition using an arcuate wall 218, where each arcuate wall 218 extends across one face 212, 214, or 216 of the grow module 200 and is generally used to support plants 124.

Notably, it is desirable according to exemplary embodiments to form a substantial seal between partitions 206 and liner 120. Therefore, according to an exemplary embodiment, grow module 200 may define a grow module diameter 220 (e.g., defined by its substantially circular footprint formed in a horizontal plane). Similarly, enclosed back portion 130 of liner 120 may be substantially cylindrical and may define a liner diameter 222. In order to prevent a significant amount of air from escaping between partitions 206 and liner 120, liner diameter 222 may be substantially equal to or slightly larger than grow module diameter 220.

Referring now specifically to FIG. 3, gardening appliance 100 may further include a motor 230 or another suitable driving element or device for selectively rotating grow module 200 during operation of gardening appliance 100. In this regard, according to the illustrated embodiment, motor 230 is positioned below grow module 200, e.g., within mechanical compartment 140, and is operably coupled to grow module 200 along central axis 204 for rotating grow module 200.

As used herein, “motor” may refer to any suitable drive motor and/or transmission assembly for rotating grow module 200. For example, motor 230 may be a brushless DC electric motor, a stepper motor, or any other suitable type or configuration of motor. For example, motor 230 may be an AC motor, an induction motor, a permanent magnet synchronous motor, or any other suitable type of AC motor. In addition, motor 230 may include any suitable transmission assemblies, clutch mechanisms, or other components.

According to an exemplary embodiment, motor 230 may be operably coupled to controller 174, which is programmed to rotate grow module 200 according to predetermined operating cycles, based on user inputs (e.g., via touch buttons 172), etc. In addition, controller 174 may be communicatively coupled to one or more sensors, such as temperature or humidity sensors, positioned within the various portions 210 of chamber 122 for measuring temperatures and/or humidity, respectively. Controller 174 may then operate motor 230 in order to maintain desired environmental conditions for plants 124 on each face 212, 214, and 216 of the grow module 200. For example, gardening appliance 100 may include features for providing certain locations of gardening appliance 100 with light, temperature control, proper moisture, nutrients, and other requirements for suitable plant growth. Motor 230 may be used to position a specific one of the faces 212, 214, and 216 where needed to receive such growth requirements, and/or may be used to rotate each face, e.g., all three faces in the illustrated exemplary embodiments, through the various portions 210 of the grow chamber 122.

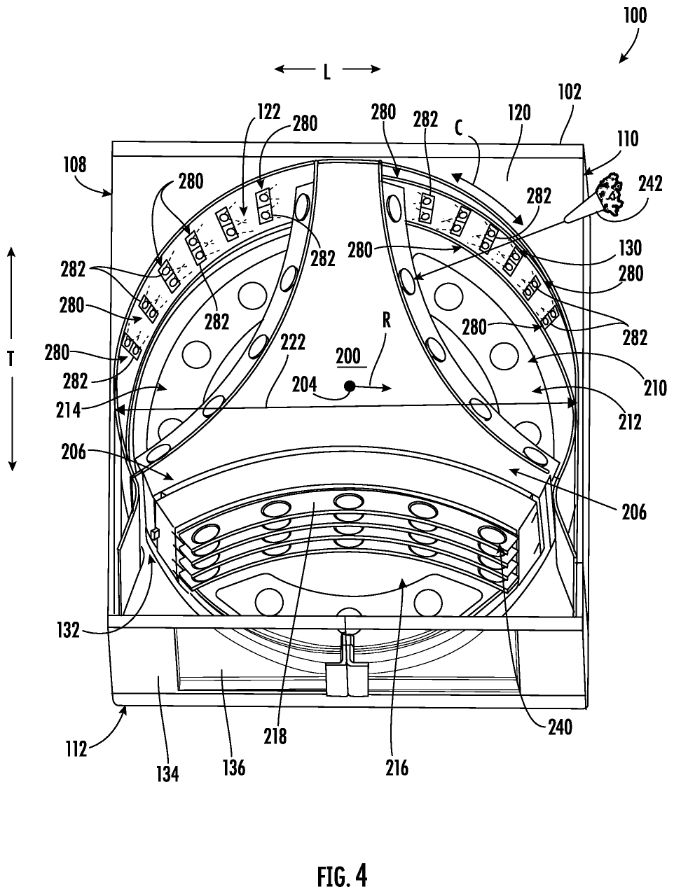

According to an exemplary embodiment, such as where the grow module 200 includes three partitions 206 and three faces 212, 214, and 216, controller 174 may operate motor 230 to index grow module 200 sequentially through a number of preselected positions. More specifically, motor 230 may rotate grow module 200 in a counterclockwise direction (e.g., when viewed from a top of grow module 200, as in FIG. 4, for example) in 120° increments to move the faces 212, 214, and 216 between sealed positions and display positions. As used herein, a face 212, 214, or 216 is considered to be in a “sealed position” when that face 212, 214, or 216 is substantially sealed between grow module 200 (i.e., central hub 202 and adjacent partitions 206) and liner 120. By contrast, a face 212, 214, or 216 is considered to be in a “display position” when that face 212, 214, or 216 is at least partially exposed to front display opening 132, such that a user may access plants 124 positioned on that face 212, 214, or 216.

For example, as illustrated in FIGS. 4 and 5, first face 212 and second face 214 are both in a sealed position, whereas third face 216 is in a display position. As motor 230 rotates grow module 200 by 120 degrees in the counterclockwise direction, second face 214 will enter the display position, while first face 212 and third face 216 will be in the sealed positions. Motor 230 may continue to rotate grow module 200 in such increments to cycle faces 212, 214, and 216 between these sealed and display positions.

Referring now generally to FIGS. 4 through 8, grow module 200 defines a plurality of pod apertures 240 defined in each face 212, 214, and 216 which are generally configured for receiving plant pods 242 into an internal root chamber 244. Plant pods 242 generally contain seedlings or other material for growing plants positioned within a mesh or other support structure through which roots of plants 124 may grow within grow module 200. A user may insert a portion of plant pod 242 (e.g., a seed end or root end 246) having the desired seeds through one of the plurality of pod apertures 240 into root chamber 244. A plant end 248 of the plant pod 242 may remain outboard of the respective face 212, 214, or 216 such that plants 124 may grow from grow module 200 such that they are accessible by a user. In this regard, grow module 200 defines root chamber 244, e.g., within at least one of central hub 202 and the plurality of partitions 206. As will be explained below, water and other nutrients may be supplied to the root end 246 of plant pods 242 within root chamber 244. Notably, pod apertures 240 may be covered by a flat flapper seal (not shown) to prevent water from escaping root chamber 244 when no plant pod 242 is installed.

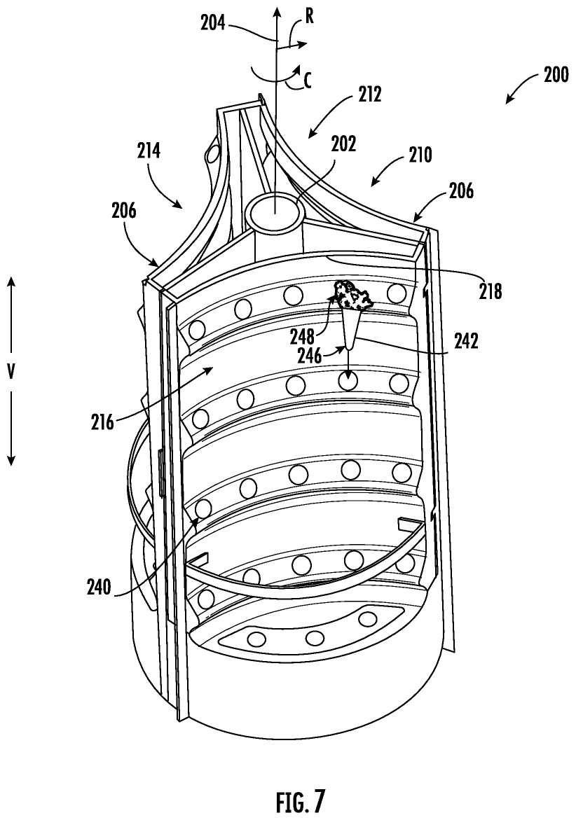

As best shown in FIGS. 5 and 7, grow module 200 may further include an internal divider 250 that is positioned within root chamber 244 to divide root chamber 244 into a plurality of root chambers, each of the plurality of root chambers being in fluid communication with one of the plurality of portions 210 of grow chamber 122 through the plurality of pod apertures 240. More specifically, according to the illustrated embodiment, internal divider 250 may divide root chamber 244 into a first root chamber 252, a second root chamber 254, and a third root chamber 256. According to an exemplary embodiment, first root chamber 252 may provide water and nutrients to plants 124 positioned in an aperture of the first face 212, second root chamber 254 may provide water and nutrients to plants 124 positioned in an aperture of the second face 214, and third root chamber 256 may provide water and nutrients to plants 124 positioned in an aperture of the third face 216. In this manner, environmental control system 148 may control the temperature and/or humidity of each of the plurality of root chambers 252-256 independently of each other.

Notably, environmental control system 148 described above is generally configured for regulating the temperature and humidity (e.g., or some other suitable water level quantity or measurement) within one or all of the portions 210 of the grow chamber 122 and/or root chambers 252-256 independently of each other. In this manner, a versatile and desirable growing environment may be obtained for each and every portion 210 of the growing chamber 122.

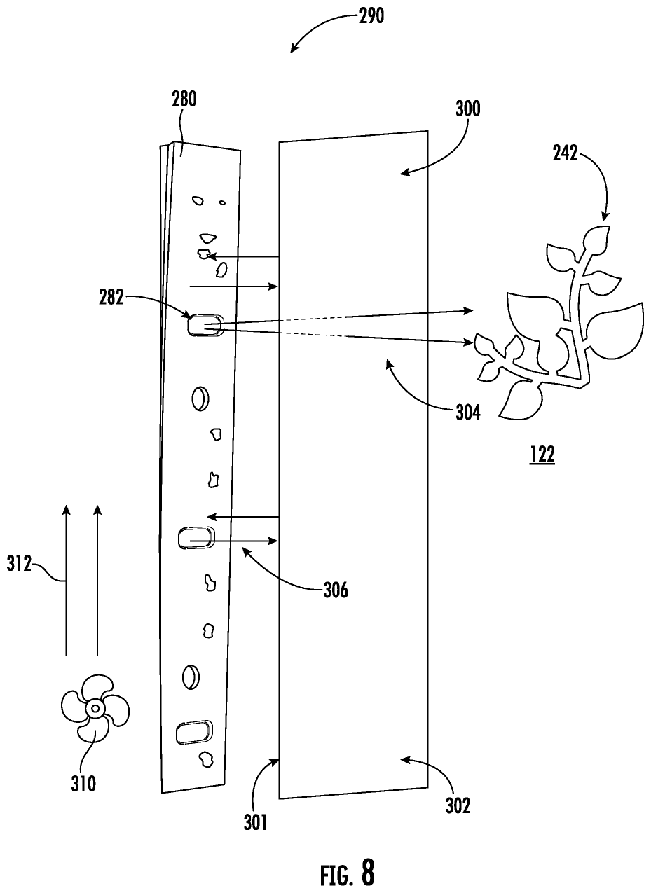

Referring now for example to FIGS. 4 and 5, gardening appliance 100 may further include an artificial lighting system including a plurality of light assemblies 280 which is generally configured for providing light into the one or more back portions 210 of the grow chamber 122 to facilitate photosynthesis and growth of plants 124. For example, each light assembly 280 may be in optical communication with one of the one or more back portions 210 of the grow chamber 122, such as in optical communication as in the illustrated example embodiments. As shown, each light assembly 280 may include a plurality of light sources 282 stacked in an array, e.g., extending along the vertical direction V. In particular embodiments, such as further described below, light sources 282 are positioned behind liner 120 such that light is projected through a transparent shield into grow chamber 122, such as further described herein. In particular, the transparent shield, such as depicted in FIG. 8, is positioned in between the light assembly 280 and the grow chamber 122. In particular embodiments, the light assembly 280, or the array of light sources 282, and the transparent shield each extend co-directional to one another relative to an axis, e.g., vertical direction V, lateral direction L, transverse direction T, or a circumferential direction relative to any one or more axes. In still particular embodiments, the array of light sources 282 is positioned along the axis co-directional to the transparent shield 300 (FIG. 8). Accordingly, the light sources 282 are in indirect optical communication with the one or more back portions 210, such as further described herein.

Light sources 282 may be provided as any suitable number, type, position, and configuration of electrical light source(s), using any suitable light technology and illuminating in any suitable color. For example, according to the illustrated embodiment, light source 282 includes one or more light emitting diodes (LEDs), which may each illuminate in a single color (e.g., white LEDs), or which may each illuminate in multiple colors (e.g., multi-color or RGB LEDs) depending on the control signal from controller 174. Additionally, light assembly 280 may include light sources 282 that are configured to emit full-spectrum light or ultraviolet light, such as one or both of type-A ultraviolet (UVA) light and type-B ultraviolet (UVB) light. However, it should be appreciated that according to alternative embodiments, light sources 282 may include any other suitable traditional light bulbs or sources, such as halogen bulbs, fluorescent bulbs, incandescent bulbs, glow bars, a fiber light source, etc.

Light generated from light assembly 280 may result in light pollution within a room where gardening appliance 100 is located. Therefore, the gardening appliance 100 may include features for reducing light pollution, or to the blocking of light from light sources 282 through front display opening 132. Specifically, as illustrated, the light assemblies 280 are positioned only within the enclosed back portion 130 of liner 120 such that only faces 212, 214, and 216 of the grow module 200 which are in a sealed position are exposed to light from light sources 282. Specifically, grow module 200 acts as a physical partition between light assemblies 280 and front display opening 132. In this manner, as illustrated in FIG. 5, no light may pass from the back portion 130 of the grow chamber 122 through grow module 200 and out front display opening 132. As grow module 200 rotates, two of the three faces 212, 214, and 216 of the grow module 200 (and plants 124 positioned in the pod apertures 240 thereof) will receive light from light assembly 280 at a time.

Gardening appliance 100 and grow module 200 have been described above to explain an exemplary embodiment of the present subject matter. However, it should be appreciated that variations and modifications may be made while remaining within the scope of the present subject matter. For example, according to alternative embodiments, gardening appliance 100 may be a simplified to a two-chamber embodiment with a square liner 120 and a grow module 200 having two partitions 206 extending from opposite sides of central hub 202 to define a first face and a second face. According to such an embodiment, by rotating grow module 200 by 180 degrees about central axis 204, the first face may alternate between the sealed position (e.g., facing rear side 114 of cabinet 102) and the display position (e.g., facing front side 112 of cabinet 102). By contrast, the same rotation will move the second face from the display position to the sealed position.

Referring now to FIG. 8, an embodiment of a thermal management system 290 for a gardening appliance is provided. The thermal management system 290 may be included in various embodiments of the gardening appliance 100 such as provided herein. FIG. 8 depicts an exploded view of a portion of the gardening appliance at which the thermal management system 290 may be positioned. The thermal management system 290 includes a transparent shield 300 positioned between the light assembly 280 and the grow chamber 122. In particular embodiments, transparent shield 300 is formed at the portion 130 of liner 120. Transparent shield 300 is formed of any appropriate material configured to allow light to pass therethrough. In particular embodiments, the transparent material is formed of a glass, a plastic, or combinations thereof. Transparent shield 300 forms a first side 301 proximate to the light assembly 282 and a second side 302 distal to the light assembly 282 or proximate to the receiving plant pod 242. In particular, first side 301 is proximate relative to light emitted from light source 280 toward grow chamber 122, and second side 302 is distal relative to light emitted from light source 280 toward grow chamber 122. In still particular embodiments, an outer surface or substrate of the transparent shield 300 is formed from one or more of the first side 301 or the second side 302.

In various embodiments, transparent shield 300 includes a wavelength filter coating configured to inhibit light wavelengths beyond a predetermined range of light wavelength from entering the grow chamber 122. Stated differently, the wavelength filter coating is configured to allow light wavelengths within the predetermined range of light wavelength into the grow chamber 122, such as to be received at plant pod 242. In various embodiments, the wavelength filter coating is applied to the outer surface or substrate of the transparent shield 300. In particular embodiments, the wavelength filter coating is applied to the first side 301 of the transparent shield 300. Additionally, or alternatively, in certain embodiments, the wavelength filter coating is applied to the second side 302 of the transparent shield 300.

In various embodiments, the predetermined range of light wavelengths is less than approximately 800 nanometers. In a particular embodiment, the predetermined range of light wavelengths is between approximately 280 nanometers and approximately 800 nanometers, or between approximately 280 nanometers and approximately 700 nanometers. Accordingly, the wavelength filter coating at the transparent shield 300 is configured to inhibit wavelengths greater than approximately 800 nm, or greater than approximately 700 nm, or less than approximately 280 nm, from passing across the transparent shield 300 to the grow chamber 122 and the planting pod 122. Furthermore, the wavelength filter coating is configured to allow wavelengths less than 800 nm, or between approximately 280 nm and approximately 700 nm, to pass through the transparent shield 300 to the grow chamber and to the planting pod 122.

Accordingly, embodiments of the gardening appliance 100 including the transparent shield 300 with wavelength filter coating such as described herein allow for beneficial spectrums of light to be received at the plant while inhibiting, removing, or otherwise filtering away wavelengths that may primarily generate heat or otherwise waste energy. For instance, UV light between approximately 280 nm and approximately 400 nm may generally include UV-A and UV-B light providing benefits corresponding to color, nutritional value, taste, and aroma at the plant. Blue light between approximately 400 nm and approximately 500 nm may provide benefits corresponding to plant growth, flowering, and plant quality. Green light between approximately 500 nm and approximately 600 nm may aid photosynthesis. Red light between approximately 600 nm and approximately 700 nm may particularly aid photosynthesis and plant biomass growth. Red light may particularly provide such benefits more efficiently in regard to plant growth and energy consumption in contrast to other spectrums. Far red radiation between approximately 700 nm and approximately 800 nm may particularly promote extension growth, leaf size, stem size, and plant height.

Additionally, embodiments of the transparent shield 300 provided herein reduce overall heat generation at the gardening appliance 100. By inhibiting wavelengths of light that are substantially non-beneficial or less beneficial, embodiments of the transparent shield 300 provided herein reduce an amount of heat to be removed from the grow chamber 122, such as via the environmental control system 148 or other thermal management system. Various embodiments provided herein inhibit approximately 50% up to approximately 100%, or up to approximately 99%, or up to approximately 95%, of undesired light wavelengths. Particularly applying the wavelength filter coating to the first side 301 of the transparent shield 300 proximate to the light source 282 may mitigate heat build-up, retention, and generation at the transparent shield 300. Accordingly, the wavelength filter coating at the first side 301 may mitigate causing the liner 120 to retain heat from the light assembly 280, or particularly mitigate causing the back portion 130 of the liner 120 to retain heat, or specifically mitigate causing transparent shield 300 to retain heat.

In certain embodiments, such as depicted in FIG. 8, the gardening appliance 100 includes an air flow device 310 positioned in fluid communication with the light assembly 280. The air flow device 310 is configured to flow air, depicted schematically via arrows 312, in thermal communication with the transparent shield 300. In particular embodiments, the air flow device 310 is positioned proximate to the first side 301 of the light assembly 280. In still particular embodiments, the air flow device 310 is configured to flow air substantially co-directional to an array of light sources 282 of the light assembly 280. In certain embodiments, the air flow device 310 is a fan, blower, nozzle, or other device configured to generate or emit a flow of cooling fluid, such as air. The air flow device 310 may be included with the environmental control system 142. Accordingly, controls and methods for controlling the environmental control system 142 may furthermore include steps for operating the air flow device 310.

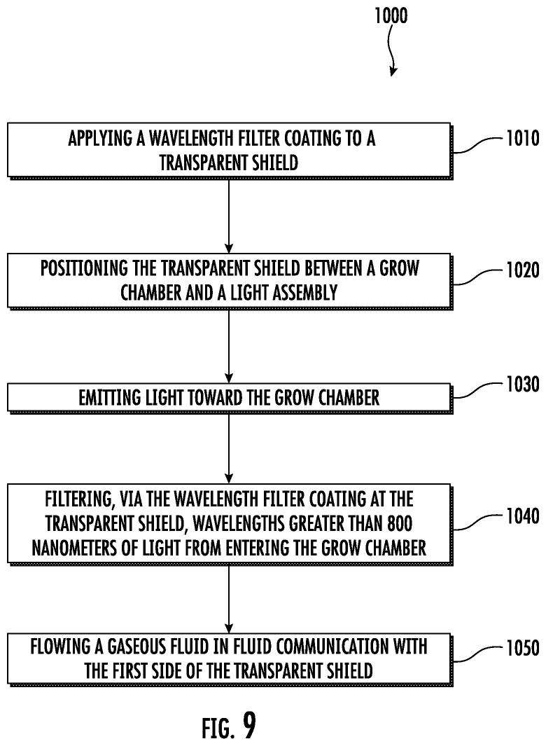

Referring now to FIG. 9, a flowchart outlining steps of a method for thermal management at a gardening appliance is provided (hereinafter, “method 1000”). Embodiments of the method 1000 may be executed or utilized for gardening systems generally including a grow chamber, or indoor gardening appliances specifically, or one or more embodiments of gardening appliance 100 particularly.

Embodiments of method 1000 include at 1010 applying a wavelength filter coating to a transparent shield (e.g., transparent shield 300). Method 1000 includes at 1020 positioning the transparent shield between the grow chamber (e.g., grow chamber 122) and the light assembly, the light assembly configured to emit light toward the grow chamber. Method 1000 includes at 1030 emitting light toward the grow chamber.

Various embodiments of the method 1000 include at 1040 filtering, via the wavelength filter coating at the transparent shield, wavelengths greater than approximately 800 nanometers of light from entering the grow chamber. Still particular embodiments of method 1000 include filtering, via the wavelength filter coating, wavelengths outside of a predetermined range of wavelengths, such as provided herein (e.g., between approximately 280 nm and approximately 800 nm).

In still various embodiments, method 1000 includes at 1050 flowing a gaseous fluid in fluid communication with the first side of the transparent shield. Flowing the gaseous fluid may include flowing air, such as depicted schematically via arrows 312 in FIG. 8, or other appropriate cooling fluid in thermal communication with the grow chamber, the light assembly, or other appropriate volumes or surfaces of the gardening appliance. Flowing the gaseous fluid may include an air flow device (e.g., air flow device 310), duct system (e.g., duct system 160), or other appropriate flow device.

In particular embodiments, such as described herein, method 1000 at 1010 includes applying the wavelength filter coating to a substrate of the transparent shield proximate to a light source (e.g., light source 282) at the light assembly. In certain embodiments, method 1000 at 1010 includes applying the wavelength filter coating to the substrate at the first side (e.g., first side 301) of the transparent shield proximate to the light source. Method 1000 at 1010 may additionally include applying the wavelength filter coating to the substrate at the second side (e.g., second side 302) of the transparent shield, such as proximate to the grow chamber and/or distal to the light source. Still further embodiments may alternatively include applying the wavelength filter coating to the substrate at the second side of the transparent shield.

In various embodiments, method 1000 at 1010 includes applying the wavelength filter coating via one or more thin film deposition processes appropriate for application onto a glass or plastic substrate of the transparent shield. The thin film deposition process may include one or more chemical vapor deposition processes (CVD), physical deposition processes (PVD), or silvering processes. In certain embodiments, the substrate may generally include an outer layer or face of the transparent shield. In particular embodiments, certain faces or sides may particularly receive the wavelength filter coating, such as provide one or more benefits as described herein.

In certain embodiments, method 1000 includes at 1010 applying the wavelength filter coating via chemical vapor deposition. In particular embodiments, method 1000 at includes at 1010 forming the wavelength filter coating based at least on a fluorinated tin dioxide (SnO₂). Method 1000 at 1010 may particularly include depositing the fluorinated tin dioxide to one or more sides (e.g., first side 301, second side 302) of the transparent shield based at least on a pyrolytic CVD process. In certain embodiments, the pyrolytic CVD process may particularly include depositing the fluorinated SnO₂ onto the first side of the transparent shield, in which the first side (e.g., first side 301) forms a glass substrate. In still particular embodiments, method 1000 at 1010 includes applying the wavelength filter coating via pyrolytic CVD at a high temperature (e.g., above approximately 250 degrees Celsius). However, it should be appreciated that embodiments of the method 1000 may include pyrolytic CVD processes at relatively low temperatures, or other CVD methods.

In still certain embodiments, method 1000 includes at 1010 applying the wavelength filter coating via physical vapor deposition. Various embodiments of method 1000 at 1010 may include applying the wavelength filter coating via magnetron sputtering onto the first side of the transparent shield. In various embodiments, the first side forms a substrate. The substrate may include glass, plastic, or other appropriate material, or combinations thereof.

In various embodiments, the transparent shield includes a glass or plastic substrate in which the wavelength filter coating includes magnesium fluoride, a fluoropolymer, or other appropriate thin film composition such as described herein.

Various embodiments of the method 1000 or transparent shield 300 may include applying the wavelength filter coating to substantially all or part of the transparent shield. In certain embodiments, various light sources may output various light wavelengths different from one another. Method 1000 may include selectively applying the wavelength filter coating based on a location from which light is received from the light source. For instance, the transparent shield may be configured to block thermal radiation from UV lights and allow wavelengths from the visible spectrum. Various embodiments of the coating may be configured for reduced transmissivity in the visible spectrum, opacity in the infrared spectrum, and full transmission or allowance through the transparent shield in the ultraviolet range.

Embodiments of the gardening appliance 100 and method for thermal management 1000 provided herein may improve energy efficiency at gardening appliances by reducing undesired thermal radiation into the grow chamber, allowing for reduced energy consumption by an environmental control system or other cooling or thermal management system. Improving thermal management may facilitate growing conditions for plants, reduce the risk of wilting, and facilitate maintaining desired environmental conditions for the plant. Embodiments provided herein may reduce water consumption, such as via reducing undesired thermal radiation and associated heat generation, which may reduce undesired evaporation and water consumption. Still further, reduced cooling and thermal management usage may reduce overall noise associated with operating an environmental control system, cooling system, or other thermal management system. Embodiments of the method and appliance provided herein may allow for relatively lower operating speeds and durations at compressors, fans, motors, or other motive devices.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A gardening appliance, comprising:
a cabinet defining a grow chamber within the cabinet;
a light assembly configured to emit light into the grow chamber;
a transparent shield positioned between the light assembly and the grow chamber, the transparent shield comprising a wavelength filter coating, wherein the coating is configured to inhibit light wavelengths beyond a predetermined range of light wavelength from entering the grow chamber.

2. The gardening appliance of claim 1, wherein the transparent shield comprises a first side proximate to the light assembly and a second side distal to the light assembly, and wherein the coating is at the first side of the transparent shield.

3. The gardening appliance of claim 2, wherein the light assembly comprises a light source, and wherein the first side of the transparent shield is proximate to the light source.

4. The gardening appliance of claim 1, wherein the predetermined range of light wavelengths is less than approximately 800 nanometers.

5. The gardening appliance of claim 1, wherein the predetermined range of light wavelengths is between approximately 280 nanometers and approximately 800 nanometers.

6. The gardening appliance of claim 1, wherein the light assembly and the transparent shield each extend co-directional along relative to an axis, and wherein the light assembly comprises a light source positioned along the axis, and wherein the transparent shield is positioned between the light source and the grow chamber.

7. The gardening appliance of claim 1, wherein the coating is a thin film coating formed from a chemical vapor deposition process.

8. The gardening appliance of claim 7, wherein the transparent shield comprises a glass substrate, and wherein the thin film coating comprises fluorinated tin dioxide.

9. The gardening appliance of claim 1, wherein the coating is a thin film coating formed from a magnetron sputtering process.

10. The gardening appliance of claim 1, comprising:
an air flow device positioned in fluid communication with the light assembly, the air flow device configured to flow air in thermal communication with a first side of the transparent shield proximate to the light assembly.

11. A method for thermal management at a gardening appliance, wherein the gardening appliance forms a grow chamber, the method comprising:
applying a wavelength filter coating to a transparent shield;
positioning the transparent shield between the grow chamber and the light assembly, the light assembly configured to emit light toward the grow chamber; and
emitting light toward the grow chamber.

12. The method of claim 11, wherein applying the wavelength filter coating comprises applying the wavelength filter coating via chemical vapor deposition onto a glass substrate at the transparent shield.

13. The method of claim 11, wherein applying the wavelength filter comprises applying the wavelength filter coating via pyrolytic chemical vapor deposition.

14. The method of claim 13, wherein applying the wavelength filter coating via pyrolytic chemical vapor deposition comprises depositing fluorinated tin dioxide to a glass substrate at the transparent shield.

15. The method of claim 14, wherein the glass substrate at the transparent shield is at a first side of the transparent shield, wherein the first side is proximate to the light source at the light assembly.

16. The method of claim 11, wherein applying the wavelength filter coating comprises applying the wavelength filter coating via magnetron sputtering onto a substrate at the transparent shield.

17. The method of claim 11, wherein applying the wavelength filter coating comprises applying the wavelength filter coating via a silvering process.

18. The method of claim 11, wherein applying the wavelength filter coating comprises applying a thin film coating comprises magnesium fluoride or a fluoropolymer.

19. The method of claim 11, the method comprising:
filtering, via the wavelength filter coating, wavelengths greater than approximately 800 nanometers of light from entering the grow chamber.

20. The method of claim 11, the method comprising:
flowing a gaseous fluid in fluid communication with a first side of the transparent shield.
